(19) United States
(12) Patent Application Publication
(10) Pub. No.: US 2023/0360029 A1
(43) Pub. Date: Nov. 9, 2023

(54) NON-FUNGIBLE TOKENS FOR STADIUM SEATS AND TICKETS

(71) Applicant: Cyber Secure Mobile Payments, Inc., Nashville, TN (US)

(72) Inventors: Scott M. Pranger, Nashville, TN (US); Cory D. Raines, Nashville, TN (US)

(21) Appl. No.: 18/311,372

(22) Filed: May 3, 2023

Related U.S. Application Data
(60) Provisional application No. 63/337,996, filed on May 3, 2022.

(51) Int. Cl. G06Q 20/36; G06Q 20/04; G06Q 20/40; G06Q 20/10

(52) U.S. Cl. CPC G06Q 20/3672; G06Q 20/0457; G06Q 20/401; G06Q 20/10; G06Q 20/3678; G06Q 2220/00

(57) ABSTRACT

The system and methods discussed herein can generate one or more non-fungible tokens (NFTs) associated with event spaces. The disclosed system can receive a one or more assets associated with a physical entity and create one or more asset NFTs individually associated with a respective one of the plurality of assets. The disclosed system can generate one or more tickets. The disclosed system can create ticket NFTs individually associated with a respective asset of the assets and based on the respective asset. The ticket NFTs can be for a particular event at the physical entity. The disclosed system can determine whether to grant access to a particular asset at the physical entity during the particular event based on analyzing a particular ticket NFT of the ticket NFTs that are associated with the particular asset.

### CROSS-REFERENCE TO RELATED APPLICATIONS

This application claims the benefit of and priority to U.S. Provisional Patent Application No. 63/337,996, entitled “Ticket NFTs—Non-fungible Token Stadium Seats & Tickets,” filed May 3, 2022, the entire contents and substance of which is incorporated herein by reference as if fully set forth below.

### TECHNICAL FIELD

The present systems and processes relate generally to a trackable ticketing system using non-fungible tokens (NFTs) and blockchain infrastructures.

### BACKGROUND

Technology has played an important role in the evolution of ticketing for live events. Long gone are the days of having to wait in lines at will-call to pick up a coveted ticket for a famous band's live performance. Current technologies allow clients to exchange tickets online and receive them electronically. One issue with current and old ticketing systems is the inability to track ticket exchanges after the initial exchange between the client and an entity providing the event. For example, when the entity exchanges a ticket with the client, the first exchange is trackable. Continuing this example, if the client decides to resell the ticket, the entity will be unaware of the subsequent exchange. Additionally, there are no systems or methods that allow the entity to regain a certain amount of value from an increased ticket rate during subsequent exchanges. Therefore, there exists an unresolved need for systems and methods that can generate trackable tickets for tracking ownership and recuperating value after subsequent exchanges of the trackable tickets.

### BRIEF SUMMARY OF DISCLOSURE

Briefly described, and according to one embodiment, aspects of the present disclosure generally relate to systems and methods for enabling value distribution from the exchange of event tickets using non-fungible tokens (NFTs). In at least one embodiment, the present system includes techniques for assigning a venue seat (e.g., sporting event venue seat, concert venue seat, theater venue seat) to an NFT (referred to herein as an Ticket NFT). The present system can allow owners of a stadium or of seats in a stadium (referred to herein as entities) to assign each physical seat to one or more NFTs. The Ticket NFT for each particular venue seat can be associated with a ticket in any particular ticketing system including a physical ticket, a digital ticket, an Ticket NFT, etc. The Ticket NFT can be created by the entity hosting the event (e.g., sports team, band, concert organizer, play company, cinema company) and offered to any particular client for exchange on a centralized platform using a centralized cryptocurrency. In particular embodiments, the Ticket NFT sold by the entity is associated to the venue seat, allowing the entity in possession of the venue seat to receive a portion of the gains produced from the Ticket NFT's exchange. In some embodiments, distributing event tickets using NFTs and assigning them to a particular venue seat NFT on a centralized platform can facilitate safer security practices, greater tracking of exchanges, and increased funds for entities hosting the particular event.

An exchange application can create an NFT for each seat. The exchange application can create NFTs for each particular physical seat and assign the newly minted venue seat NFTs to the particular entity in possession of the venue seat. When an event is held at the stadium, exchange application can create tickets that are linked to venue seat NFTs. The tickets can correspond to Ticket NFTs. The exchange application can create an easily trackable asset for each particular event ticket. In some embodiments, whenever Ticket NFTs are resold for particular event tickets, the entities associated with the Ticket NFT can earn a percentage of the subsequent exchanges. For example, the current ticket holders can sell their tickets on the exchange application where other clients can exchange them using bank and/or credit card information or using cryptocurrencies associated with the exchange application. The exchange application can present Ticket NFTs and other goods and services for exchange to one or more clients.

Combining venue seating with the NFT blockchain system can provide several advantages to entities hosting the event and the clients receiving the Ticket NFTs. In at least one embodiment, the use of Ticket NFTs on a centralized platform can provide the entities an opportunity to capitalize on increased funds from successive exchanges of the Ticket NFTs. In one or more embodiments, using the blockchain infrastructure for event tickets provides easier tracking of transactions and increased security. The Ticket NFT, using the blockchain infrastructure can provide a uniquely identifiable ticket with a trackable ownership. In at least one embodiment, the blockchain keeps a running record of each transaction associated with the Ticket NFT. For example, when the Ticket NFT of a particular identifiable seat in a stadium is created (referred to synonymously as “minted”), the Ticket NFT creation record is stored in a blockchain. Continuing this example, once the Ticket NFT is originally sold, a uniquely identifiable transaction record is produce pointing to the location of the original Ticket NFT on the blockchain. Continuing this example, each subsequent exchange made after the original exchange includes its own record, where the record identifies the original location of the Ticket NFT on the blockchain. As this information is uneditable, the constant recording of exchanges may provide a clear path illustrating the transactions associated with an Ticket NFT. In one or more embodiments, given the uneditable nature of the blockchain, the Ticket NFT, and the records of transaction, the client receiving the event ticket can have upmost confidence that the ticket is not fraudulent. In at least one embodiment, since Ticket NFTs are linked to a unique seat in a stadium, the client can confirm which seat they are actually receiving through the blockchain record of the Ticket NFT.

In various embodiments, the exchange application can utilize multi-signature authentication frameworks for validating and processing transactions related to Ticket NFTs, cryptocurrencies, and venue seat NFTs. In at least one embodiment, the exchange application can generate and maintain multi-signature digital wallets for storing Ticket NFTs of particular events or cryptocurrency. The exchange application can implement asymmetric key techniques and algorithms to provide data integrity to sign and authorize transactions associated with a multi-signature digital wallets. In various embodiments, to utilize assets held in the multi-signature digital wallet, the exchange application requires submission and validation multiple cryptographic signatures or keys (e.g., each of which may function as a partial password for any Ticket NFT or cryptocurrency transactions into or out of the wallet). The multiple cryptographic signatures can be approved by the same authority or each cryptographic signature can be approved by a different approval authority. The multi cryptographic signatures may be required to exchange Ticket NFTs and move the Ticket NFTs into a client's wallet. In one embodiment, the exchange application can require authentication of two cryptographic signatures to initiate transactions for the multi-signature digital wallet. In one embodiment, the exchange application can receive a first cryptographic signature from a user at a first online portal and a second cryptographic signature at a second online portal to process a client's request to exchange Ticket NFTs for a particular event. In some embodiments, the first online portal can be associated with a first approval authority and the second online portal can be associated with a second approval authority that may be unaffiliated with the first approval authority.

These and other aspects, features, and benefits of the claimed innovation(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates an exchange system, according to one embodiment of the present disclosure;

FIG. 2 illustrates a first example exchange workflow, according to one embodiment of the present disclosure;

FIG. 3 illustrates a second example exchange workflow, according to one embodiment of the present disclosure;

FIG. 4 illustrates a flowchart of a process, according to one embodiment of the present disclosure; and

FIG. 5 illustrates a flowchart of a process, according to one embodiment of the present disclosure.

### DETAILED DESCRIPTION

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

For the purpose of promoting an understanding of the principles of the present disclosure, reference will now be made to the embodiments illustrated in the drawings and specific language will be used to describe the same. It will be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Aspects of the present disclosure generally relate to systems and methods for enabling value distribution from the exchange of event tickets using non-fungible tokens (NFTs). In at least one embodiment, the present system includes techniques for assigning a venue seat (e.g., sporting event venue seat, concert venue seat, theater venue seat) to an NFT (referred to herein as an Ticket NFT). The present system can allow owners of a stadium or of seats in a stadium (referred to herein as entities) to assign each physical seat to one or more NFTs. The Ticket NFT for each particular venue seat can be associated with a ticket in any particular ticketing system including a physical ticket, a digital ticket, an Ticket NFT, etc. The Ticket NFT can be created by the entity hosting the event (e.g., sports team, band, concert organizer, play company, cinema company) and offered to any particular client for exchange on a centralized platform using a centralized cryptocurrency. In particular embodiments, the Ticket NFT sold by the entity is associated to the venue seat, allowing the entity in possession of the venue seat to receive a portion of the gains produced from the Ticket NFT's exchange. In some embodiments, distributing event tickets using NFTs and assigning them to a particular venue seat NFT on a centralized platform can facilitate safer security practices, greater tracking of exchanges, and increased funds for entities hosting the particular event.

In some embodiments, the Ticket NFT can represent a unique stadium seat NFT stored on a blockchain. The blockchain can be a storage technology used for saving data on decentralized networks. For example, the blockchain can be used as a digital ledger of transactions made using cryptographic tokens and/or NFTs along with their assigned monetary values. In at least one embodiment, NFT stands for non-fungible token. In some embodiments, non-fungible is a term used to describe items that are not interchangeable for other items because the items have unique properties. For example, NFTs can be tokens used to represent ownership of unique items such as art, an individual seats in a stadium, collectibles, and real estate. In at least one embodiment, an NFT can only have one official owner at a time. In some embodiments, the majority of NFTs are secured by the Ethereum blockchain but can be secured by any particular blockchain technique. In particular embodiments, the record of ownership may be non-volatile (e.g., it is not possible to modify) for a particular NFT. In some embodiments, a particular NFT may be unable to be copied and pasted into a new NFT.

Combining venue seating with the NFT blockchain system can provide several advantages to entities hosting the event and the clients receiving the Ticket NFTs. In at least one embodiment, the use of Ticket NFTs on a centralized platform can provide the entities an opportunity to capitalize on increased funds from successive exchanges of the Ticket NFTs. Commonly before, entities did not have the opportunity to capitalize on the aftermarket exchanges of event tickets. For example, after the original exchange of the event ticket with the particular entity, a client could resell the event ticket for an increased charge. Continuing this example, the particular entity will not benefit from the increased funds produced from the subsequent exchange of the event tickets. An exchange application can create an NFT for each seat. The exchange application can create NFTs for each particular physical seat and assign the newly minted venue seat NFTs to the particular entity in possession of the venue seat. When an event is held at the stadium, exchange application can create tickets that are linked to venue seat NFTs. The tickets can correspond to Ticket NFTs. The exchange application can create an easily trackable asset for each particular event ticket. In some embodiments, whenever Ticket NFTs are resold for particular event tickets, the entities associated with the Ticket NFT can earn a percentage of the subsequent exchanges. For example, the current ticket holders can sell their tickets on the exchange application where other clients can exchange them using bank and/or credit card information or using cryptocurrencies associated with the exchange application. The exchange application can present Ticket NFTs and other goods and services for exchange to one or more clients.

In one or more embodiments, using the blockchain infrastructure for event tickets provides easier tracking of transactions and increased security. The Ticket NFT, using the blockchain infrastructure can provide a uniquely identifiable ticket with a trackable ownership. In at least one embodiment, the blockchain keeps a running record of each transaction associated with the Ticket NFT. For example, when the Ticket NFT of a particular identifiable seat in a stadium is created (referred to synonymously as “minted”), the Ticket NFT creation record is stored in a blockchain. Continuing this example, once the Ticket NFT is originally sold, a uniquely identifiable transaction record is produce pointing to the location of the original Ticket NFT on the blockchain. Continuing this example, each subsequent exchange made after the original exchange includes its own record, where the record identifies the original location of the Ticket NFT on the blockchain. As this information is uneditable, the constant recording of exchanges may provide a clear path illustrating the transactions associated with an Ticket NFT. In one or more embodiments, given the uneditable nature of the blockchain, the Ticket NFT, and the records of transaction, the client receiving the event ticket can have upmost confidence that the ticket is not fraudulent. In at least one embodiment, since Ticket NFTs are linked to a unique seat in a stadium, the client can confirm which seat they are actually receiving through the blockchain record of the Ticket NFT.

The present system can include the exchange application, a centralized source for distributing Ticket NFTs. The exchange application can correspond to a software system executed on one or more computing devices that manages generation, distribution, and ownership of the Ticket NFTs. In some embodiments, the exchange application can be accessed and/or managed through a mobile device, computing system, or any particular electronic device. For example, the exchange application can include a particular sub application within a general StaksPay application. In various embodiments, the particular entities can employ the StaksPay application to mint and distribute Ticket NFTs for a particular event. For example, the B atlanta Mawks can be referred to as an entity for a particular basketball game at the Spilhip Arena and can offer Ticket NFTs for each seat through the exchange application. As the operator of an event, the entity can offer the Ticket NFT of a particular seat for the particular event for exchange with the public. In some examples, the entities can include, but are not limited to, a sports team, a music festival organizer, a band, a music venue, a theatrical venue, a season ticket holder, a box seat holder, and/or a production organizer.

In various embodiments, the exchange application can utilize multi-signature authentication frameworks for validating and processing transactions related to Ticket NFTs, cryptographic tokens, and venue seat NFTs. In at least one embodiment, the exchange application can generate and maintain multi-signature digital wallets for storing Ticket NFTs of particular events or cryptocurrency. The exchange application can implement asymmetric key techniques and algorithms to provide data integrity to sign and authorize transactions associated with multi-signature digital wallets. In various embodiments, to utilize assets held in the multi-signature digital wallet, the exchange application requires submission and validation multiple cryptographic signatures or keys (e.g., each of which may function as a partial password for any Ticket NFT or cryptocurrency transactions into or out of the wallet). The multiple cryptographic signatures can be approved by the same authority or each cryptographic signature can be approved by a different approval authority. The multi cryptographic signatures may be required to exchange Ticket NFTs and move the Ticket NFTs into a client's wallet. In one embodiment, the exchange application can require authentication of two cryptographic signatures to initiate transactions for the multi-signature digital wallet. In one embodiment, the exchange application can receive a first cryptographic signature from a user at a first online portal and a second cryptographic signature at a second online portal to process a client's request to exchange Ticket NFTs for a particular event. In some embodiments, the first online portal can be associated with a first approval authority and the second online portal can be associated with a second approval authority that may be unaffiliated with the first approval authority.

The client, an individual receiving the Ticket NFT can employ the StaksPay application to browse various Ticket NFTs. For example, the StaksPay application can include a portal, such as the exchange application, for exploring the Ticket NFTs of particular events. In some embodiments, the Ticket NFTs can be offered on any particular NFT exchange application, where the StaksPay application can present the NFT exchange application to the client. The exchange application can show seating maps for particular events. In at least one embodiment, the exchange application shows a list of all seats available for exchange as Ticket NFTs. The exchange application can show metadata about each Ticket NFT to the client. As an example, the exchange application can show which tickets are obtainable from clients and which tickets are officially provided by the particular entity. The exchange application can accept a request to exchange a Ticket NFT for either a cryptocurrency (e.g., StaksCoin) or a credit/debit card. The StaksPay application includes a MyWallet feature to administer exchanges of Ticket NFTs, cryptographic tokens, and/or any other asset. Once the particular Ticket NFT is exchanged, the ownership of the Ticket NFT is transferred to the new acquirer using multi-signature digital wallets. In one or more embodiments, if the Ticket NFT is exchanged from a client, the stadium owner receives a portion of the rate of exchange. In one or more embodiments, if the Ticket NFT is exchanged by the client at a greater rate as compared to the original exchange by the particular entity hosting the event, the particular entity can receive a portion of the rate of exchange. For example, in one embodiment, if the Ticket NFT for an event seat is sold at a rate above the original exchange rate from the entity, reaching a particular threshold, the entity receives a portion of the exchange rate. In other embodiments, the particular entity can receive a portion of any exchange regardless of the exchange rate.

### Exemplary Embodiments

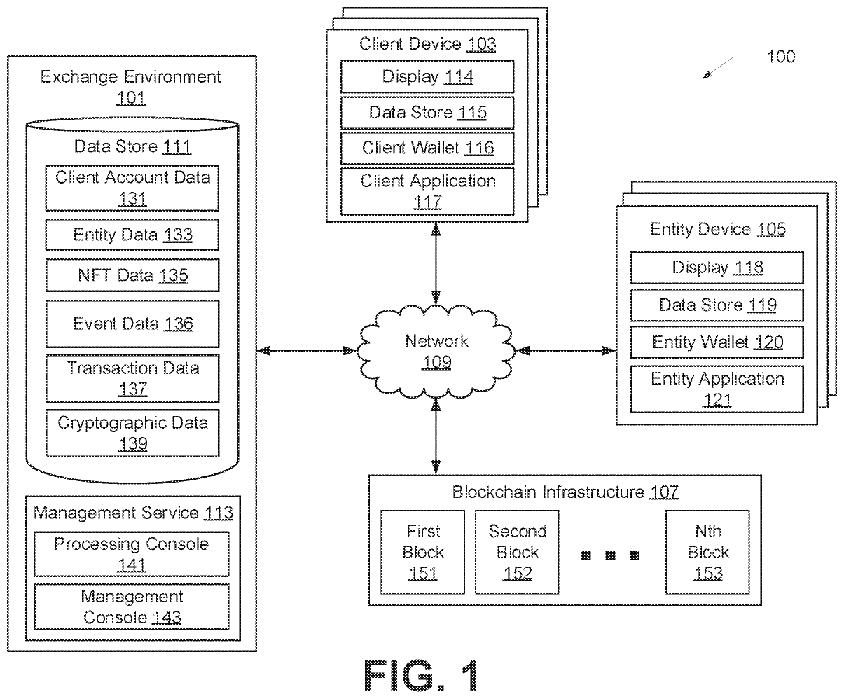

Referring now to the figures, for the purposes of example and explanation of the fundamental processes and components of the disclosed systems and processes, reference is made to FIG. 1, which illustrates an example exchange system 100. As will be understood and appreciated, the exchange system 100 shown in FIG. 1 represents merely one approach or embodiment of the present concept, and other aspects are used according to various embodiments of the present concept.

The exchange system 100 can illustrate an example system for generating asset NFTs and ticket NFTs (also referred to as unique tokens) using a blockchain infrastructure 107. The exchange system 100 can allow one or more entities hosting one or more events to provide tickets for particular seats in a venue (e.g., sports arena, concert hall, amphitheater, etc.) using NFT systems (e.g., the blockchain infrastructure 107). The exchange system 100 can generate asset NFTs for one or more seats in a stadium. The exchange system 100 can generate one or more ticket NFTs associated with each of the asset NFTs. For example, a particular ticket NFT can be linked to an asset NFT representing a seat located in section 5, row 21, seat number 18 of a particular stadium. Continuing this example, the ticket NFT can grant access to the asset when presented at the stadium for the particular event. The ticket NFTs can be distributed on a client application 117 to one or more clients. The clients can be defined as users of the exchange system 100 obtaining ticket NFTs for use at a particular venue and/or event. The entity hosting the event can upload the ticket NFTs through an entity application 121 to the client application 117. The client application 117 can allow clients to exchange a particular cryptocurrency specific to the client application 117 for any particular ticket NFT.

By generating NFTs for each ticket, the ticket NFT can provide greater advantages as compared to traditional electronic barcode tickets and paper tickets. For example, the ticket NFTs can include smart contracts, which define one or more conditions necessary for executing an exchange of ownership of the particular ticket NFT (or any particular NFT thereof). Continuing this example, the smart contract can be imbedded with conditions such as a minimum price for exchange, percentage distribution back to the original entity and/or owner of the asset NFT, and minimum age of client receiving the ticket NFT. The ability to embed the ticket NFT with self-executing conditions as source code can allow the entity to define any particular conditions necessary to execute an exchange of ownership for the particular ticket NFT. Contrary to previous technologies, the ticket NFT can allow entities to recuperate value from subsequent exchanges of the ticket NFT between one or more clients. The ticket NFT can provide a trackable exchange through the blockchain infrastructure 107 to guarantee the ticket NFT is legitimate and properly linked to the asset NFT. By proving ownership and legitimacy, the ticket NFT can provide clients with confidence they are not receiving a fraudulent item.

The exchange system 100 can include an exchange environment 101, one or more client devices 103, one or more entity devices 105, and the blockchain infrastructure 107, which can be in data communication with each other via a network 109. The network 109 can include, for example, the Internet, intranets, extranets, wide area networks (WANs), local area networks (LANs), wired networks, wireless networks, or other suitable networks, etc., or any combination of two or more such networks. For example, such networks can include satellite networks, cable networks, Ethernet networks, Bluetooth networks, Wi-Fi networks, near field communication (NFC) networks, and other types of networks.

The exchange environment 101 can include, for example, a server computer or any other system providing computing capability. Alternatively, the exchange environment 101 can employ more than one computing devices that can be arranged, for example, in one or more server banks or computer banks or other arrangements. Such computing devices can be located in a single installation or can be distributed among many different geographical locations. For example, the exchange environment 101 can include one or more computing devices that together can include a hosted computing resource, a grid computing resource, and/or any other distributed computing arrangement. In some cases, the exchange environment 101 can correspond to an elastic computing resource where the allotted capacity of processing, network, storage, or other computing-related resources can vary over time.

Various applications and/or other functionality can be executed in the exchange environment 101 according to various embodiments. Also, various data can be stored in a data store 111 that is accessible to the exchange environment 101. The data store 111 can be representative of one or more of data stores 111 as can be appreciated. The data stored in the data store 111, for example, can be associated with the operation of the various applications and/or functional entities described below.

The components executed on the exchange environment 101, for example, can include list of applications, and other applications, services, processes, systems, engines, or functionality not discussed in detail herein. The exchange environment 101 can include a management service 113. The management service 113 can function as the central computing module of the exchange environment 101. The management service 113 can perform all processing necessities of the exchange environment 101, the client devices 103, and/or the entity devices 105. The management service 113 can include a processing console 141 and a management console 143.

The processing console 141 can perform all computational requirements of the exchange environment 101, the client devices 103, and/or the entity devices 105. The processing console 141 can, for example, generate cryptographic keys for one or more multi-signature authentication procedures for validating and processing one or more exchanges of NFTs. In another example, the processing console 141 can generate asset NFTs and ticket NFTs (also referred to herein as “minting” NFTs). The processing console 141 can perform statistical analyses and/or computational analyses on the data stored in the data store 111. The processing console 141 can perform one or more functionalities discussed in further detail herein.

The management console 143 can distribute data within the exchange environment 101 and/or to other devices located on the network 109. For example, the management console 143 can store data received from the client device 103 in the data store 111. The management console 143 can transfer data from the data store 111 to the processing console 141. For example, the processing console 141 can request event data 136 from the data store 111 for minting one or more ticket NFTs. Continuing this example, the management console 143 can retrieve the requested event data 136 and send the requested event data 136 to the processing console 141. The management console 143 can send data to the client devices 103, the entity device 105, the blockchain infrastructure 107, and/or any other resource distributed on the network 109.

The data stored in the data store 111 can include, for example, list of data, and potentially other data. The data store can include a client account data 131, an entity data 133, an NFT data 135, an event data 136, a transaction data 137, and a cryptographic data 139.

The client account data 131 can include any information associated with the particular client device 103. The client account data 131 can include, for example, a client name, a client home address, a client banking information, a client age, a client device 103 Media Access Control (MAC) address, a client device 103 Internet Protocol (IP) address, a client credit card information, a client entity preferences, a client e-mail address, a client phone number, and/or any other particular information associated with the client. The client account data 131 can be linked to a particular client device 103. The client account data 131 can be linked to a client wallet 116.

The entity data 133 can include any data associated with the one or more entities. For example, the entity data 133 can include an entity name, an entity address, an entity venue type, an entity venue name, entity asset list, an entity size, and/or any other information associated with the one or more entities. The entity asset list of the entity data 133 can include any information associated with the assets of the particular entity. Assets can include, but are not limited to, specific seats in the venue, private box area of the venue, and venue sections. In various embodiments, the assets can include any particular object offered by the entity that can be minted as an NFT. The entity data 133 can be linked to a particular entity device 105.

The NFT data 135 can include data associated with minted asset NFTs and minted ticket NFTs. For example, the NFT data 135 can include but is not limited to an NFT type, an NFT name, a smart contract associated with a particular NFT, smart contract address, wallet addresses, transaction addresses, and/or any particular information associated with the one or more NFTs. The NFT data 135 can be associated with particular entity data 133, particular transaction data 137, particular client account data 131, one or more client devices 103, one or more client wallets 116, one or more entity devices 105, and/or the blockchain infrastructure 107. For example, the NFT data can include ticket NFT for a particular baseball game. The ticket NFT can be linked to the entity data 133 and the entity device 105 hosting the particular baseball game. Continuing this example, the ticket NFTs for the particular baseball game can be stored in the NFT data 135 and or the entity wallet 120. When an exchange for one or more ticket NFTs for the particular baseball game are processed, the ticket NFTs may be sent from the NFT data 135 and/or the entity wallet 120 to the client device 103.

The event data 136 can include any information associated with events hosted by the one or more entities. The event data 136 can include, for example, event name, event type, event total capacity, event optimal capacity, event seating arrangement, event location, event venue name, event date, and/or any particular information associated with the event. For example, the event data 136 can include a data entry that states the name of a musical performance, the location of the musical performance, the capacity of the venue for the music performance, the number of open seats, and the total number of seats.

The transaction data 137 can include all data related to transactions performed between one client device 103 and one entity device 105, one client device 103 and another client device 103, one entity device 105 and another entity device 105, and/or a client device 103 and the exchange environment 101. For example, transaction data 137 can include but is not limited to transaction identification numbers, type of transaction, entity associated with the transaction, user associated with the transaction, cost of transaction, the date of the transaction, the asset or ticket NFT associated with the transaction, and smart contract conditions associated with the transaction. In various embodiments, a transaction can be defined as an exchange of proprietary cryptocurrencies (e.g., StaksCoin or other cryptographic tokens) for one or more ticket NFTs. Transactions can be performed using any particular currency for exchange. For example, the transaction data 137 can include the type of currency used (e.g., credit, debit, cash, money, third party cryptocurrencies, proprietary cryptocurrencies) and the amount used for the exchange. The transaction data 137 can include one or more exchange rates. The exchange rates can include but are not limited to an exchange rate between StaksCoins and a particular ticket NFT and an exchange rate between StaksCoin and third-party cryptocurrency.

The cryptographic data 139 can include any data associated with authenticating one or more exchanges performed between the client devices 103, the entity devices 105, and/or the exchange environment 101. The cryptographic data 139 can include private keys, public keys, cryptographic signatures, list of fraudulent transactions, list of approved transactions, list of hostile client devices 103, and/or any other cryptographic information associated with the exchange environment 101, the client devices 103, and/or the entity devices 105. For example, the cryptographic data can include one or more private RSA keys and one or more public RSA keys for generating one or more cryptographic signatures and verifying the one or more generated cryptographic signatures.

The client device 103 can be representative of a one or more client devices that can be coupled to the network 109. The client device 103 can include, for example, a processor-based system such as a computer system. Such a computer system can be embodied in the form of a desktop computer, a laptop computer, personal digital assistants, cellular telephones, smartphones, set-top boxes, music players, web pads, tablet computer systems, game consoles, electronic book readers, or other devices with like capability. The client device 103 can include a display 114 for rendering various information on the client device 103. The display 114 can include, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The client device 103 can be configured to execute various applications such as a client application 117 and/or other applications. The client application 117 can be executed in a client, for example, to access network content served up by the exchange environment 101 and/or other servers, thereby rendering a user interface on the display 114. To this end, the client application 117 can include, for example, a browser, a dedicated application(e.g., an exchange application), etc., and the user interface can include a network page, an application screen, etc. The client device 103 can execute applications beyond the client application 117 such as, for example, email applications, social networking applications, word processors, spreadsheets, and/or other applications. The client application, for example can render an exchange application of the client device 103. The exchange application can allow client device 103 to select various ticket NFTs for exchange, edit client information and client account data 131, follow entity specific events, exchange cryptographic tokens for ticket NFTs, and/or exchange StaksCoin for objects or third-party cryptocurrencies.

The client device 103 can include a data store 115. The data store 115 can be substantially similar to the data store 111. The data store 115 can share data with the data store 111 and vise-versa. For example, the data store 115 can be an extension of the data store 111. The data store 115 can include data not stored in the data store 111. For example, the data store 115 can include various private keys local to the client device 103.

The client device 103 can include a client wallet 116 for storing, maintaining, and distributing cryptocurrencies and ticket NFTs associated with the client account data 131 of the specific client device 103. The client wallet 116 can be associated to a particular client account data 131. The client wallet 116 can function as a multi-signature digital wallet for protecting the cryptocurrencies and ticket NFTs stored within. For example, the exchange environment 101 and/or the client device 103 can implement asymmetric key techniques and algorithms to provide data integrity to sign and authorize transactions associated with the client wallet 116 (e.g., a cryptographic wallet). To utilize the cryptocurrencies and ticket NFTs held in the client wallet 116, the client device 103 can require submission and validation of multiple cryptographic signatures or keys (e.g., each of which may function as a partial password for any (dis)allowing award point or cryptocurrency transactions into or out of the wallet). The multi cryptographic signatures may be required to place a reward (e.g., StaksCoin) into the client wallet 116. Although illustrated as a component of the client device 103, the client wallet 116 can be stored in the exchange environment 101, where the exchange environment 101 performs all the maintenance and management of the client wallet 116.

The entity device 105 can be representative of a one or more entity devices that can be coupled to the network 109. The entity device 105 can include, for example, a processor-based system such as a computer system. Such a computer system can be embodied in the form of a desktop computer, a laptop computer, personal digital assistants, cellular telephones, smartphones, set-top boxes, music players, web pads, tablet computer systems, game consoles, electronic book readers, or other devices with like capability. The entity device 105 can include a display 118 for rendering various information on the entity device 105. The display 118 can include, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The entity device 105 can be configured to execute various applications such as an entity application 121 and/or other applications. The entity application 121 can be executed in a client, for example, to access network content served up by the exchange environment 101 and/or other servers, thereby rendering a user interface on the display 118. To this end, the entity application 121 can include, for example, a browser, a dedicated application, etc., and the user interface can include a network page, an application screen, etc. The entity device 105 can execute applications beyond the entity application 121 such as, for example, email applications, social networking applications, word processors, spreadsheets, and/or other applications.

The entity device 105 can include a data store 119. The data store 119 can be substantially similar to the data store 111 and the data store 115. The data store 119 can share data with the data store 111 and the data store 115, and vise-versa. For example, the data store 119 can be an extension of the data store 111. The data store 119 can include data not stored in the data store 111. For example, the data store 119 can include various private keys local to the entity device 105. In another example, the data store 119 can include one or more asset NFT data stored locally on the entity device 105

The entity device 105 can include an entity wallet 120 for storing, maintaining, and distributing cryptocurrencies, ticket NFTs, and asset NFTs associated with the entity data 133 of the specific entity device 105. The client wallet 116 can be associated to a particular entity from the entity data 133. The entity wallet 120 can function for the entity device 105 substantially similarly to how the client wallet 116 functions for the client device 103.

The blockchain infrastructure 107 can include a distributed ledger system for tracking and recording exchanges performed in the exchange system 100. The blockchain infrastructure 107 can include a public blockchain network (e.g., Bitcoin network, Ethereum network), a private blockchain network, or a hybrid blockchain network. For example, the exchange environment 101 can record exchanges of ticket NFTs between the client devices 103, the entity devices 105, and/or the exchange environment 101 to the Ethereum network as a first block 151. The blockchain infrastructure 107 can include one or more computing devices and one or more memory devices for processing and storing a blockchain ledger. The blockchain ledger can be distributed across the one or more computing devices, which may be located in a single location or different locations. The Blockchain infrastructure 107 can include a second block 152 and an Nth block 153. The second block 152 can illustrate a second exchange recorded on the blockchain infrastructure 107 by the exchange environment 101, the client devices 103, and/or the entity device 105. The Nth block 153 can illustrate that the exchange environment 101 can record more than two exchanges onto the blockchain infrastructure 107. In some embodiments, the blockchain infrastructure 107 is incorporated as a component of the exchange environment 101.

The exchange environment 101 and/or the blockchain infrastructure 107 can record an asset and/or ticket to the blockchain infrastructure 107 to create an NFT. For example, the entity device 105 can send a list of seats at a venue owned by the entity. Continuing this example, the exchange environment 101 can mint an asset NFT for each particular seat by recording a digital asset representation of each particular seat as one or more blocks on in the blockchain infrastructure 107. By recording each digital asset representation of each particular seat, the blockchain infrastructure 107 can generate asset NFTs for each digital asset representation of each particular seat. The exchange environment 101 can store the asset NFTs in the entity wallet associated with the particular entity to digitally identify the official owner of the seats at the particular venue. In various embodiments, the entity device 105 can interact with the blockchain infrastructure 107 to perform the minting and storing process locally.

When an event is planned, the entity device 105 can send information associated with the event to the exchange environment 101. Information sent by the entity device 105 can include but is not limited to the type of event, the capacity, the location, the name, the date, the seats available, and the various smart contract source code for executing exchanges associated with each ticket for each seat. The processing console 141 can create one or more ticket NFTs using data representing at least one set of parameters for generating individually ones of the one or more ticket NFTs associated with a respective one of the one or more asset NFTs. For example, the exchange environment 101 can generate a digital ticket (e.g., a ticket NFT) representing a ticket for each particular seat (e.g., an asset NFT) at the particular event. For example, the exchange environment 101 can generate a digital ticket (e.g., a .JPEG, a .GIF, a .PDF) with a photo of the seat, the seat number, the row, the section, and the name, date, and title of the event for each particular seat sanctioned for the particular event. The exchange environment 101 can employ the blockchain infrastructure 107 to mint various ticket NFTs associated with various digital tickets and smart contracts for each particular seat. For example a first ticket NFT can be minted for a first seat and have a first smart contract. The first ticket NFT can be associated to the asset NFT defining the exact chare the ticket NFT is granting access to. The first smart contract can define the conditions for which the ticket NFT can be exchanged.

Next, a general description of the operation of the various components of the exchange system 100 is provided. In some embodiments, using the blockchain infrastructure 107 for tokenizing tickets of events can help facilitate increased exchange rates amongst the entities. For example, the exchange environment 101 can provide a percentage of subsequent exchanges to the entities when one or more ticket NFT are exchanged more than once. In one or more embodiments, the ticket NFTs associated with the asset NFTs can be available on any open blockchain system and in the client application 117 (e.g., Staks Marketplace, StaksPay Application, exchange application, or a combination thereof). In various embodiments, client device 103 can employ the client application 117 to allow clients to exchange listed ticket NFTs for particular events. The client application 117, the exchange environment 101, the entity device 105, and/or the blockchain infrastructure 107 can provide additional sources of revenue for entities such as minting and selling limited edition digital NFT cards for an athlete who broke a record or performed a historic feat.

In some embodiments, the processing console 141 can receive a cataloged seat chart from the entity device 105. Although discussed in the context of the processing console 141, any particular system (e.g., exchange environment 101, the client device 103, entity device 105, and/or blockchain infrastructure 107) can perform the processes and functionalities of processing console 141 discussed herein. The processing console 141 can index the received seating catalogue and store the received seating catalog in the event data 136 of the data store 111. The processing console 141 can process the indexed seating catalogue and verify the entities' possession of the seats in the catalogue. For example, the processing console 141 can use identification information associated with the entity stored in the entity data 133 and/or any other particular identifier to identify the authenticity of the indexed seats. In one embodiment, similar to a bank vault, the processing console 141 can employ the entity wallet 120 to store access to these indexed seats along with the ability to sign and authorize the transfer of the indexed seats. The entity device 105 can sign and authorize the transfer of indexed seats using a system that requires more than one private key, known as a multi-signature wallet. In some embodiments, the multi-signature wallet can require multiple passwords to access. In one embodiment, usage of each private key requires entry of a key-specific password from a user that corresponds to the private key. As a non-limiting example, three users may each have one private key, and the system may require approval from all three private keys in order to transfer ownership of an NFT, a related NFT, or cryptographic token. Once the authentication of the seats and the entity are approved, the processing console 141 can employ the blockchain infrastructure 107 to mint the data for the seats on to the blockchain as asset NFTs and along with one or more smart contracts. For example, when minting NFTs for a numbered seat, the processing console 141 can use standard ERC-721 tokens on the Ethereum blockchain.

The processing console 141 can mint the ticket NFTs as tickets for various events hosted by the entity. In various embodiments, one or more smart contracts associated with the ticket NFTs can dictate the conditions required for the exchange of the ticket NFTs associated to a unique asset NFT. With the smart contracts established, the processing console 141 can make available for exchange the ticket NFTs in the public market of the blockchain as well as in the client application 117. In various embodiments, the client application 117 is only available for clients and entities associated with the exchange environment 101. The ticket NFTs can be associated with a unique asset NFT for any particular event.

In one or more embodiments, the exchange system 100 can provide the entities a portal used to customize smart contracts through the entity application 121. The entity application 121 can function as the centralized sources for entities to manage distribution, minting, uploading, and/or any other information associated with events, associated ticket NFTs, and asset NFTs. For example, the entity application 121 can provide the entites the ability to edit purchasing conditions, listing time, and/or any other information associated with the smart contracts of one or more ticket NFTs. In at least one embodiment, the entity application 121 can allow entities the opportunity to negotiate and set reimbursement fees and conditions when a client device 103 exchanges a ticket NFT after receiving the ticket NFT from the entity device 105 or from another client device 103.

In some embodiments, the difficulty of establishing a NFT wallet and/or a cryptocurrency wallet can discourage users from adopting a blockchain system for buying and selling ticket NFTs, asset NFTs, or any other blockchain enabled tradable good. In various embodiments, the client application 117 can automatically create the client wallet 116 (e.g., MyWallet) for the clients, reducing the hassles associated with purchasing ticket NFTs and/or asset NFTs. For example, the client application 117 can accept credit card and bank account information to exchange StaksCoin. The client device 103 can store the StaksCoin in the client wallet 116 for subsequent exchanges of ticket NFTs and/or asset NFTs. The processing console 141 can generate cryptographic keys for use in the client wallet 116. The entity wallet 120 can function substantially similar to the client application 117.

During particular events, not every ticket can have its own identifiable feature. For example, soccer games at some stadiums can have a ticket associated to a uniquely identifiable seat. A concert can have a general admission section where there are no seats at the same stadium. During an open seating event, such as the general admissions section of a concert, the processing console 141 can mint the ticket NFTs and/or asset NFTs as Semi-Fungible NFTs. In various embodiments, Semi-Fungible NFTs can be referred to as ERC-1155 tokens on the Ethereum blockchain. In at least one embodiment, the Semi-Fungible NFTs are a specific type of NFT that represent items with a fixed quantity. For example, the set of Semi-Fungible NFTs for a general admissions concert venue can be the number of open seats in a given stadium. In at least one embodiment, the set of Semi-Fungible NFTs represent a series of open spots in an open seating environment. The processing console 141 can employ the blockchain infrastructure 107 to create a set of Semi-Fungible NFTs for a particular event and publish them to the client application 117.

In particular embodiments, the processing console 141 and/or the blockchain infrastructure 107 can provide unique NFTs for sectioned areas that are distinct from other sections but contain unassigned seats (e.g., VIP section of a music festival, box seats of a football game). The processing console 141 can provide the unique NFTs as Semi-Fungible NFTs with their particular conditions (e.g., section designation) managed and tracked within the smart contract, transaction of the NFT, or any other internal record system of the application.

In some embodiments, the processing console 141 can employ the blockchain infrastructure 107 to process the transfer of ownership of exchanged Ticket NFTs. In at least one embodiment, the processing console 141 can structure smart contracts in the blockchain infrastructure 107 in a manner that the entity device 105 that initially owns the ticket NFT always collects a portion of the exchange whenever the ticket NFT is exchanged to a new client device 103. For example, the entity device 105 can collect a portion of an exchanged ticket NFT when the ticket NFT is sold at a threshold above the original set value of the ticket NFT. In various embodiments, the processing console 141 tracks the ownership and payments associated with a particular ticket NFT. In some embodiments, the processing console 141 automatically collect the increased value form the subsequent exchange and deposits the gains into the entity wallet 120. The term “automatic” as used herein can refer to functionally performed by a computing device with limited or no user interaction being required.

In some embodiments, any particular NFT can only have one owner at a time. For example, the processing console 141 can manage the ownership of the uniqueID and metadata of the asset NFT that no other NFT can replicate. In at least one embodiment, the processing console 141 mints ticket NFTs and asset NFTs using smart contracts. In various embodiments, the processing console 141 can employ the smart contracts to assign ownership and manage the transferability of the NFTs to clients and/or entities. When the processing console 141 creates one or more NFTs for a particular event and/or stadium seat, the processing console 141 can execute code stored in smart contracts that conform to different standards (e.g., ERC-721). In particular embodiments, the processing console 141 can add the transaction information to the blockchain infrastructure 107 as the first block 151, the second block 152, or the nth block 153.

In particular embodiments, NFTs can have some special properties that make them ideal for the resale market. For example, each NFT minted by the processing console 141 and/or the blockchain infrastructure 107 can have a unique identifier that is directly linked to one Ethereum address. The ticket NFT can point to the address of the asset NFT. By associating the event ticket NFT, or any particular ticket type, to the asset NFT, the entity device 105 and/or the client device 103 can receive a portion of the exchange produced by exchanging the ticket NFT. In another example, the ticket NFTs may not be directly interchangeable with other tokens. For example, one StaksCoin cryptocurrency can differ from a second StaksCoin cryptocurrency. NFTs do not have an identical counterpart. In another example, each asset NFT may have an owner (e.g., client and/or entity) and this information can be easily verifiable. In another example, asset NFTs and/or ticket NFTs can live on Ethereum and can be bought and sold on any Ethereum-based NFT market.

In various embodiments, using NFTs for event seating provides the ability for the processing console 141 to write special conditions that need to be met for a particular transaction to take place. In various embodiments, the processing console 141 can manage the special conditions by using smart contract. For example, the smart contract is substantially similar to an automated storefront. Continuing this example, the smart contract may represents the entities offering for a particular ticket NFT along with the conditions for purchasing it. The client application 117 can render the event ticket NFT on the display 114 along with the smart contract for sale. In various embodiments, the entity device 105 can receive a request from the client device 103 to exchange the particular ticket NFT. After verifying that the conditions for the exchange have been met, the processing console 141 and/or the blockchain infrastructure 107 can use the smart contract to automatically execute the transaction without the need for a third party or moderator. In some embodiments, the processing console 141 can use the smart contracts to offer entity devices 105 new methods for managing the market of their ticket NFTs. In at least one embodiment, the ticket NFTs sold by the entity devices 105 can be associated with the asset NFTs. By associating the ticket NFTs to the asset NFTs, client devices 103 can verify the legitimacy of the ticket NFTs and entities can receive a portion of the exchange and subsequent exchanges of the ticket NFTs. As additional events occur, the processing console 141 and/or the blockchain infrastructure 107 can generate ticket NFTs for each event and associate each of the ticket NFTs with a corresponding asset NFT. For example, a the processing console 141 can associate a first ticket NFT for seat 302d at a first event with a first asset NFT for seat 302d and a second ticket NFT for seat 302d at a second event can be associated with the first asset NFT.

In various embodiments, the a common form of NFTs are referred to as static NFTs. When created, the metadata (the actual content encoded within the unique tokenlD) attached to the NFT may be fixed. In various embodiments, Dynamic NFTs can allow updating of the metadata of an NFT based on external conditions. In particular embodiments, the processing console 141 and/or the blockchain infrastructure 107 can mint static NFTs, dynamic NFTs, or a combination thereof for the one or more ticket NFTs, the one or more asset NFTs, and/or any other type of NFT. In at least one embodiment, the processing console 141 can routinely check for changes to external conditions of dynamic NFTs. In at least one embodiment, the processing console 141 can use an oracle to update external conditions of dynamic NFTs. In certain embodiments, the oracle can be defined as a system of the processing console 141 and/or the blockchain infrastructure 107 for the NFTs and their smart contracts to communicate with other sources to update and verify information.

In some embodiments, this function proves useful because it allows the processing console 14 to perform particular actions. In at least one or more embodiments, the processing console 141 can create additional NFTs by uploading digital assets to the blockchain infrastructure 107 (known as minting), remove access to others (known as burning) to address issues of supply and demand, track peer-to-peer trading, and check the state of the marketplace. For example, in the case an event is cancelled, the processing console 141 can reimburse the owners of the ticket NFTs and burn the ticket NFTs to remove them from circulation.

For example, if a particular client device 103 who exchanged a particular ticket NFT for their seat to another client device 103 exchanges the ticket NFT well above what most people are exchanging the ticket NFTs for, the processing console 141 can increase the value of the ticket NFTs using dynamic NFTs, driving increased returns to the entity device 105 who is hosting the event associated with the ticket NFTs.

In one or more embodiments, the StaksPay application can employ the smart contract to mint limited edition NFTs based on conditions that are tracked through the use of the oracle. For example, the StaksPay application can create a smart contract that automates the minting of a limited edition digital hockey card if the oracle informs it that the player achieved a hat-trick (a remarkable achievement made three times in a given match).

In at least one embodiment, the ability for the processing console 141 to create event-based NFTs opens up a new source of growth for the entities. For example, the entity devices 105 can employ the processing console 141 to offer additional NFTs for sale based on data captured in their stadium (e.g., a video of a star player's record setting performance).

In one or more embodiments, the processing console 141 can drive customer engagement by providing recompenses for frequent support. Instead of traditional paper or digital tokens, the processing console 141 can offer the entity devices 105 the ability to mint limited-time tokens as NFTs that are distributed to client devices 103 based on the level of interaction with the particular entity.

In particular embodiments, the processing console 141 can mint particular NFTs based on unique intellectual property. The processing console 141 can offer for sale the NFTs based on unique intellectual property as “shares”. In particular embodiments, this enables investors and fans the ability to own a part of the intellectual property without having to buy all rights to the intellectual property.

In one or more embodiments, the processing console 141 can use smart contracts to mimic a time-based resource. For example, the processing console 141 can use the smart contracts to define a value for a particular ticket NFT based on a time period. The processing console 141 can remove the value of the ticket NFT if the current time is outside of the time window defined by the smart contract. In at least one embodiment, the smart contract can start with the preferred NFT standard defined by a timestamp on creation. In particular embodiments, the processing console 141 can disable the ticket NFT of a particular event if the current time falls outside of a time window and can destroy the smart contract after a deadline has passed.

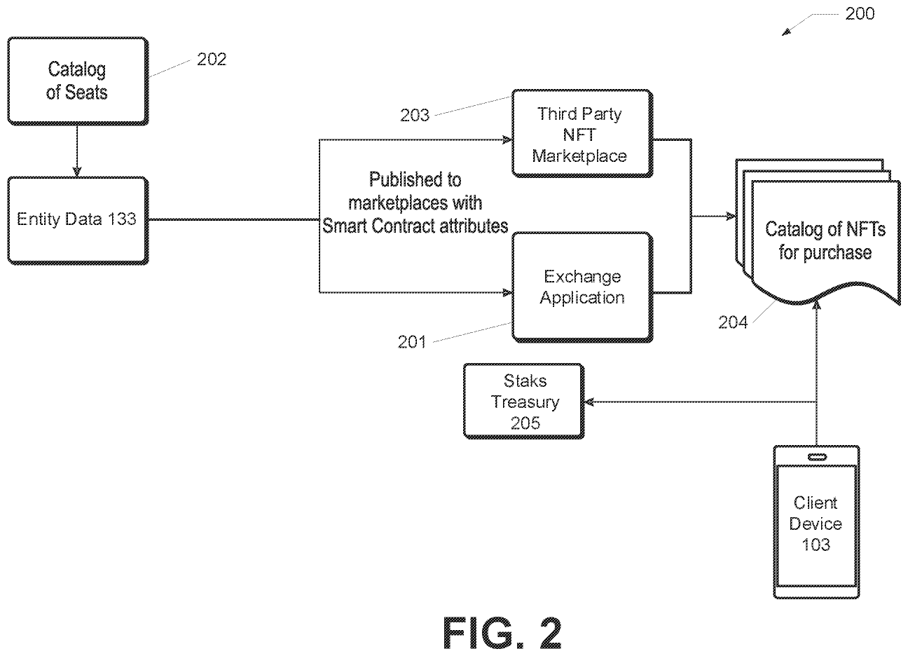

Referring now to FIG. 2, illustrated is a first example exchange workflow 200, according to one embodiment of the present disclosure. In some embodiments, the entity device 105 can use an exchange application 201 within the client application 117 and/or the entity application 121 to list and distribute ticket NFTs. The exchange application 201 can include a portal within the client application 117 and/or the entity application 121 that allows the entity device 105 to list and manage ticket NFT and entity NFTs. The exchange application 201 can allow client devices 103 to exchange cryptocurrencies for ticket NFTs.

The processing console 141 can receive a catalog of seats 202 for a particular event from the entity device 105. For example, the entity device 105 can employ the entity application 121 to render a portal for entities to log into and provide event information and one or more catalog of seats 202. Continuing this example, the processing console 141 can use multi-factor authentication (e.g., two factor, three factor, or another number of factors), public-key cryptography (e.g., RSA cryptosystem/public key infrastructure (PKI)), and or any other authentication technique to verify the authenticity of the entity device 105 accessing and providing information to the exchange environment 101. Each seat in the catalog of seats 202 may have a unique identification distinguishing itself from all other seats. For example, the unique identification for the seats can include, but is not limited to, stadium level, section, row, and seat number. On receiving the catalog of seats, the processing console 141 can index and verify the cataloged seats with the collection of identifying information of the entity data 133 associated with the entity device 105 and the entity wallet 120 of the entity device 105. For example, on creating a stadium owner account through the entity application 121, the processing console 141 receives various identification information regarding the entity and store the identification information as entity data 133. The identification information can include location data, stadium size data, number of seats in the stadium, stadium maximum capacity, stadium seating arrangement, entity wallet 120 information (e.g., MyWallet), and/or any other information pertaining to entity. In some embodiments, the processing console 141 and/or the blockchain infrastructure 107 can mint ticket NFTs and associate the asset NFTs to a singular entity device 105 and store the ticket NFTs and the asset NFTs in the entity wallet 120. In some embodiments, the processing console 141 can mint and publish the ticket NFTs after indexing and verifying the catalog of seats 202 and associating the ticket NFTs to the asset NFTs. In at least one embodiment, the ticket NFTs can be any type of ticket and may not always be an NFT. By linking the event ticket to the venue seat NFT using the processing console 141, the entity device 105 can receive a portion of an exchange produced from the subsequent exchanges of ticket NFTs between client devices 103. The processing console 141 can publish the ticket NFTs onto third-party NFT marketplaces 203 for exchange.

In at least one embodiment, processing console 141 can design smart contracts, discussed in further detail herein, to assign attributes to the ticket NFTs listed on the exchange application 201 and/or the third-party NFT marketplace 203. For example, the processing console 141 can publish the ticket NFTs to the third-party NFT marketplace 203 that anyone can access. Continuing this example, the processing console 141 can directly publish ticket NFTs, asset NFTs, or any particular NFT into the exchange application 201. In some embodiments, the exchange application 201 is only available to client devices 103 with the client application 117.

In some embodiments, the client device 103 includes the client wallet 116. In particular embodiments, the exchange environment 101 can provide each event entity and/or client with access to a unique digital wallet. The client application 117 can provide access to the client wallet 116 features. The entity application 121 can provide access to the entity wallet 120 features. For example, the client wallet 116 portal can provide a view of current StaksCoin balance, browse a catalog of ticket NFTs available for exchange 204 through both the third-party NFT marketplace 203 and the exchange application 201, a list of owned ticket NFTs, a list of owned asset NFTs, or a combination thereof. In at least one embodiments, payments for the NFTs can be made using StaksCoin and/or debit/credit cards. A Staks treasury 205 can process NFT exchanges using StaksCoin and/or a debit/credit card. For example, the Staks treasury 205 can process the debit/credit card for exchange of the ticket NFT and convert the dollar amount to StaksCoin. On completing this exchange, a specific amount of StaksCoin are removed from the client wallet 116 and moved to the entity wallet 120 (e.g., a reseller, an event operator). In some embodiments, the entity wallet 120 manages the revenue produced from ticket NFT sales, subsequent exchange benefits, purchasing StaksCoin, and/or any particular action affecting revenue of the entity and/or client.

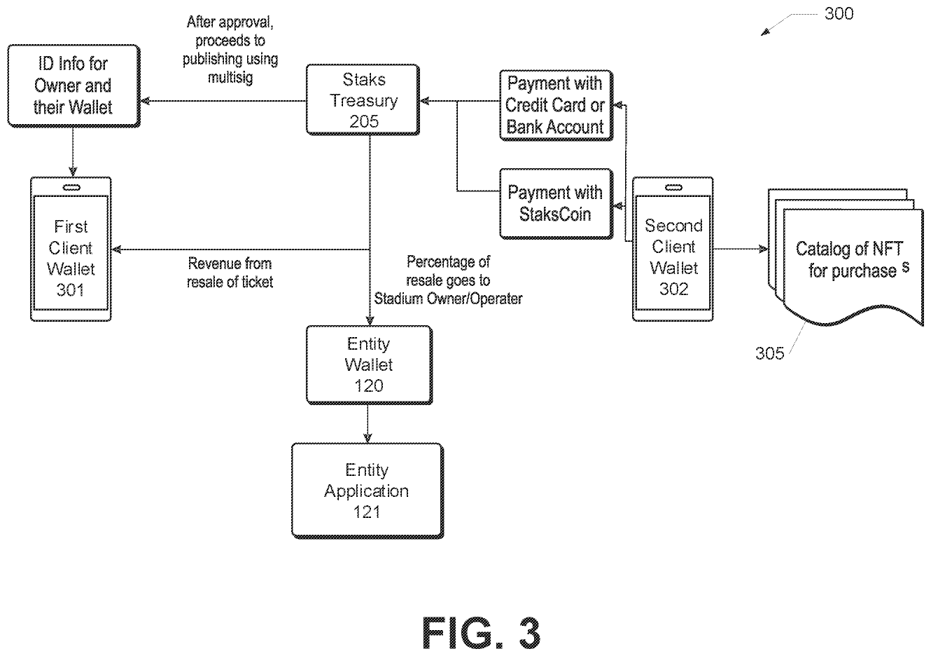

FIG. 3 illustrates a second example exchange workflow, according to one embodiment of the present disclosure. In some embodiments, the client application 117 and/or the entity application 121 can include a portal for the client wallet 116 and the entity wallet 120, respectively. In some embodiments, the client application 117 and/or the entity application 121 can display the client wallet 116 and the entity wallet 120 through the display 114 and the display 118 respectively. For example, the client wallet 116 and the entity wallet 120 can include current ticket NFTs for particular events. The client wallet 116 can also include stadium seat NFTs, event ticket NFTs, any particular ticket associated with the stadium seat NFTs, and a combination thereof.

The processing console 141 can receive a request from a first client wallet 301 to exchange a particular ticket NFT linked to a particular asset NFT in an event by publishing the NFT for sale in the exchange application 201. The processing console 141 can verify the current client device 103 associated with the first client wallet 301. The first client wallet 301 can be substantially similar to the client wallet 116. The processing console 141 can identity and confirm their possession of the ticket NFT. Once approved, the processing console 141 can publish the ticket NFT using multi-signature wallets. Once published, the exchange application 201 can display the ticket NFTs on the client application 117, where other client devices 103 (e.g., a second client wallet 302) can browse a series of ticket NFTs available for exchange. For example, the client device 103 can render a seating map with various open seats available for exchange. The processing console 141 can display ticket NFTs for sale by other client devices 103 and ticket NFTs for sale by entity device 105. In some embodiment, the first client wallet 301 of the client device 103 can receive an exchange request for the ticket NFT. In various embodiments, the processing console 141 can process the exchange request and charge a particular amount for the selected ticket NFT using the StaksCoin balance or the credit/debit card from the second client wallet 302. In some embodiments, the processing console 141 records the exchange in the first client wallet 301 (e.g., an increase in revenue) and the second client wallet 302 (e.g., a deduction of money for the exchange of the ticket NFT). In some embodiments, if an exchanged ticket NFT is exchange by a reseller, the processing console 141 can transfer a portion of the resale to the entity wallet 120 of the entity device 105 and the remaining portion to the first client wallet 301 of the reseller. In some embodiments, the portion of the resale as well as other parameters of the sale are configurable by the entity device through particular smart contracts associated with the ticket NFTs. The other parameters can include a percentage of a resale that the entity device 105 obtains, a threshold amount of resell that is subject to a fee for the entity device 105, a number of times that ticket NFTs can be resold, or other parameters. In some embodiments, the processing console 141 can remove the ticket NFT from the exchange application 201 and update the seat as now belonging to the second client wallet 302. For example, the second client wallet 302 may include a new ticket NFT amongst a catalog of purchased NFTs 305, representing ownership of the recently exchanged ticket NFT. The ticket NFT can be cryptographically protected, where the second client wallet 302 is the only system that can access the ticket NFT for gaining entry into a venue.

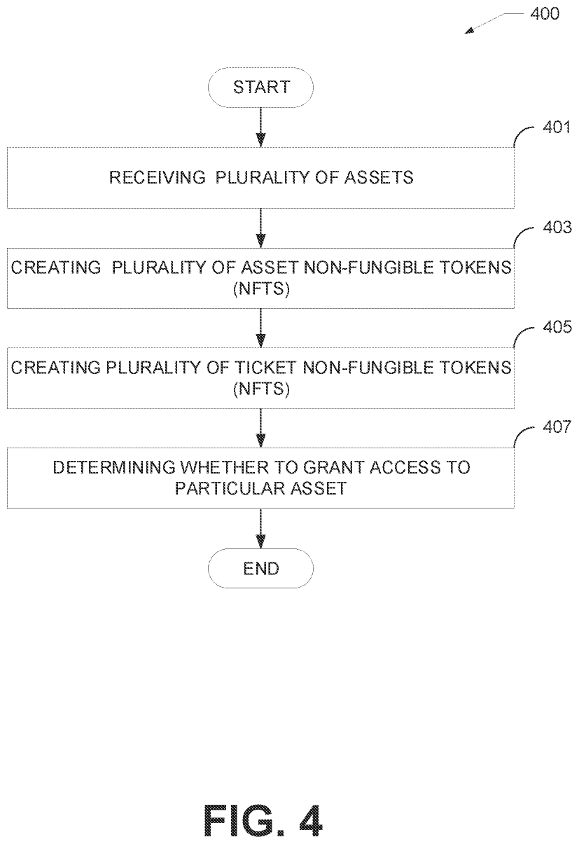

Referring now to FIG. 4, illustrated is a flowchart of a process 400, according to one embodiment of the present disclosure. The process 400 can illustrate a technique for generating one or more ticket NFTs for one or more asset NFTs and allowing entry to a client based on the ownership of the ticket NFT.

At box 401, the process 400 can include receiving one or more assets associated with a physical entity. The processing console 141 can receive the assets associated with the physical entity from the entity device 105. The assets can represent digital assets that correspond to an event space. For example, the assets can correspond to one or more seats in a venue, a general admissions area of a venue, a box area of a venue, a VIP space of a venue, an/or any particular area of a venue.

At box 403, the process 400 can include creating one or more asset NFTs individually associated with a respective one of the one or more assets. The processing console 141 and/or the blockchain infrastructure 107 can create the asset NFTs individually associated with a respective one of the assets. The processing console 141 and/or the blockchain infrastructure 107 can employ register the assets onto the blockchain infrastructure 107. By minting the assets to the blockchain infrastructure, the asset NFTs can represent unique identifiable digital assets associated with a physical location of a particular venue space of the entity.

At box 405, the process 400 can include creating a ticket NFTs individually associated with a respective asset of the assets and based on a respective asset NFT of the one or more asset NFTs associated with the respective asset, where the one or more ticket NFTs are for a particular event at the physical entity. The processing console 141 and/or the blockchain infrastructure 107 can create the ticket NFTs individually associated with the respective asset of the assets and based on the respective asset NFT of the asset NFTs associated with the respective asset, where the ticket NFTs are for the particular event at the physical entity (e.g., a stadium, concert hall, arena, festival, etc.). For example, the processing console 141 and/or the blockchain infrastructure 107 can generate a ticket NFT that is associated with a concert at a stadium. The ticket NFT can be associated with the first seat in the first row of the 101 section. The first seat in the first row of the 101 section can include a corresponding asset NFT. The processing console 141 and/or the blockchain infrastructure 107 can use the corresponding asset NFT to create a ticket NFT for the specific concert at the stadium. The processing console 141 and/or the blockchain infrastructure 107 can generate the ticket NFT and link the ticket NFT to the asset NFT.

At box 409, the process 400 can include determining whether to grant access to a particular asset at the physical entity during the particular event based on analyzing a particular ticket NFT of the ticket NFTs that is associated with the particular asset. The processing console 141 can determine whether to grant access to the particular asset at the physical entity during the particular event based on analyzing the particular ticket NFT of the ticket NFTs that is associated with the particular asset. The processing console 141 can receive a request from the client device 103 to gain access to the event using the ticket NFT. The processing console 141 can confirm that the ticket NFT is owned by a legitimate client device 103 by checking the client account data 131, the NFT data 135, and/or any other particular data. The client device 103 can render the ticket NFT on the display 114 for scanning at the particular event. The client can be granted access to the seat if the ticket NFT is associated with the particular asset (e.g., seat) and that the ticket NFT is legitimate and properly obtained.

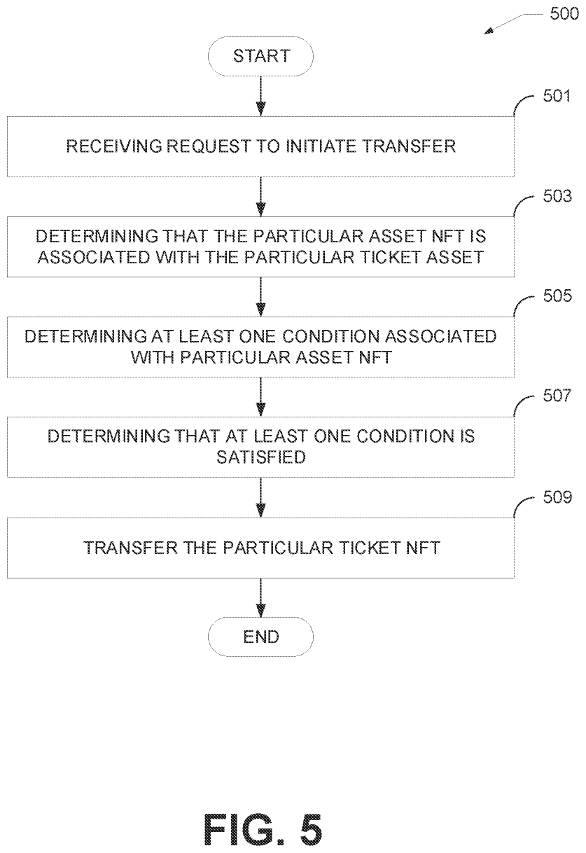

Referring now to FIG. 5, illustrated a flowchart of a process 500, according to one embodiment of the present disclosure. The process 500 can illustrate a technique for transferring one or more ticket NFTs between client devices 103, entity device 105, and/or a combination thereof.

Referring to box 501, the process 500 can include receiving a request to initiate a transfer of the particular ticket NFT to a user account, where a particular asset NFT of the asset NFTs associated with the particular assets. The processing console 141 can receive the request to initiate the transfer of the particular ticket NFT to the user account, where the particular asset NFT of the asset NFTs associated with the particular assets. The user account can be associated with the client device 103 and can be information stored in the client account data 131. The client device 103 can send a request to the exchange environment 101 to list one or more ticket NFTs and/or asset NFTs for exchange in the exchange application 201. The request can include but is not limited to a list of NFTs for exchange, a price associated with the listed NFTs, and the duration of the listing. The client device 103, after using two factor authentication and/or multi-signature authentication, can list the one or more ticket NFTs and/or asset NFTs on the exchange application 201 of the client application 117. The processing console 141 can list the ticket NFTs and/or asset NFTs for sale for the client device 103. Other client devices 103 can view the listed NFTs on the exchange application 201. For example, a second client device 103 can select a listed NFT and send a requests for exchange to the processing console 141. The processing console 141 can check the balance within the client wallet 116 of the second client device 103 to complete the purchase. On determining that the client wallet 116 has sufficient reserves to purchase the selected NFT, the processing console 141 can initiate a transfer. The processing console 141 can employ one or more authentication authorities to verify and secure a transfer from the client wallet 116 of the first client device 103 listing the NFT to the client wallet 116 of the second client device 103. Any particular security technique can be employed to secure the exchange between the first client device 103 and the second client device 103.

At box 503, the process 500 can include determining that the particular asset NFT is associated with the particular ticket NFT based on the particular ticket NFT. The processing console 141 can determine that the particular asset NFT is associated with the particular ticket NFT based on the particular ticket NFT. The processing console 141 can analyze the blockchain infrastructure 107 to identify the particular ticket NFT on the distributed ledger. For example, the processing console 141 can enter an address that identifies the location of the particular ticket NFT on the blockchain infrastructure 107. The processing console 141 can analyze the metadata, the smart contract, and/or any other information associated with the particular ticket NFT. The processing console 141 can extract an address associated with the linked particular asset NFT to identify the location of the particular asset NFT on the blockchain infrastructure 107. The processing console 141 can approve the link between the particular asset NFT and the ticket NFT by comparing records stored in the NFT data 135, the event data 136, and/or any other data in the data store 111 to confirm that the particular asset NFT and the ticket NFT are associated with the particular asset of the entity (e.g., stadium seat).

At box 505, the process 500 can include determining one or more condition associated with the particular asset NFT. The processing console 141 can determine one or more condition is associated with the particular asset NFT. The processing console 141 can extract the smart contract associated with the asset NFT. The smart contract can include the one or more conditions that define how and when the asset NFT and/or the ticket NFT can be transferred. For example, the conditions can include but are not limited to an expiration date for exchanges, a price, a client loyalty value, a trusted client list, an exchange code, and/or any particular condition that can define when and how the NFTs are transferred. For example, the condition can specify that 20% of the ticket price must be paid to a wallet associated with ownership of the asset NFT (e.g., the owner of the seat). As another example, the condition can specify that the price for the ticket NFT must meet a certain criteria, such as not falling below a minimum price threshold or not exceeding a maximum price threshold (e.g., either as a percentage of the original price or as a minimum/maximum price). As yet another example, the condition can limit a number of times that a particular ticket NFT may be transferred for a specific event.

In some embodiments, transfer of the ticket NFT can require approval from the particular entity hosting a particular event or a particular entity that owns the stadium. The processing counsel 141 can extract the smart contract associated with an event NFT or a particular entity NFT and determine one or more conditions. For example, the condition can specify a limited number of times that a particular wallet can be used for a transaction for a specific event across all ticket NFTs, which could be used to limit the ability of resellers to buy up and resell a large number of tickets. Pricing conditions as noted above can also be used to limit the ability for the resell market to inflate or deflate pricing for an event.

Referring now to box 507, the process 500 can include determining whether the at least one condition is satisfied. The processing console 141 can determine whether the at least one condition is satisfied. In one example, the processing console 141 can confirm if the price condition is met when the client device 103 makes an offer for the ticket NFT and/or the asset NFT that exceeds an embed price of 100 StaksCoin in the smart contract. In another example, the processing console 141 can confirm that a client loyalty value condition is met by reviewing the client account data 131 associated with the client device 103 requesting the exchange and confirming that the client device 103 has a certain number of client loyalty points associated with the entity providing the particular NFT. The exchange code condition can be satisfied when the processing console 141 confirms that the client device 103 sent a correct exchange code to the exchange environment 101. The trusted client list condition can be satisfied when the processing console 141 confirms that the client device 103 making the particular request is on the trusted client list of the associated entity device 105.

At box 509, the process 500 can include transferring the particular ticket NFT. The processing console 141, the client device 103, and/or the entity device 105 can transfer the particular ticket NFT to the user account in response to the at least one condition being satisfied. For example, client device 103 can perform a multi-signature authentication to send the one or more NFTs to a second client device 103. The processing console 141 can process a transaction based on the at least one condition. For example, the processing console 141 can satisfy a distribution condition when the ticket NFT and/or the asset NFT is exchange. The distribution condition can define a particular condition in the smart contract that states an amount (e.g., fixed amount or a cost percentage) that is distributed back to the original entity (e.g. original owner) that listed the ticket NFT and/or asset NFT. The processing console 141 can transfer the particular ticket NFT to the user account in response to processing the transaction. Once the one or more conditions of the smart contracts are individually and/or entirely satisfied, the client device 103 and/or the entity device 105 can send the particular NFTs to the client device 103 and/or entity device 105 initiating the exchange.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid-state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general-purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a general-purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed innovations may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represents examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed innovation are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer. As used herein, the term “at least one computing device” is intended to be any one of one or more computing devices, individually or in combination.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language, or other input devices (not shown), such as a microphone, etc. These and other input devices are often connected to the processing unit through known electrical, optical, or wireless connections.

The computer that affects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the innovations are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the innovation is connected to the local network through a network interface or adapter. When used in a WAN or WLAN networking environment, the computer may include a modem, a wireless link, or other mechanisms for establishing communications over the wide-area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

Clause 1. A system, comprising: a data store; and at least one computing device in communication with the data store, wherein the at least one computing device is configured to: receive a plurality of assets associated with a physical entity; create a plurality of asset non-fungible tokens (NFTs) individually associated with a respective one of the plurality of assets; create a plurality of ticket NFTs individually associated with a respective asset of the plurality of assets and based on a respective asset NFT of the plurality of asset NFTs associated with the respective asset, wherein the plurality of ticket NFTs are for a particular event at the physical entity; and determine whether to grant access to a particular asset at the physical entity during the particular event based on analyzing a particular ticket NFT of the plurality of ticket NFTs that is associated with the particular asset.

Clause 2. The system of clause 1 or any other clause, wherein the at least one computing device is configured to: receive a request to initiate a transfer of the particular ticket NFT to a user account, wherein a particular asset NFT of the plurality of asset NFTs associated with the particular asset; determine that the particular asset NFT is associated with the particular ticket NFT based on the particular ticket NFT; determine at least one condition associated with the particular asset NFT; determine whether the at least one condition is satisfied; and in response to the at least one condition being satisfied, transfer the particular ticket NFT to the user account.

Clause 3. The system of clause 1 or any other clause, wherein the at least one computing device is configured to: receive a request to initiate a transfer of the particular ticket NFT to a user account, wherein a particular asset NFT of the plurality of asset NFTs associated with the particular asset; determine that the particular asset NFT is associated with the particular ticket NFT based on the particular ticket NFT; determine at least one condition associated with the particular asset NFT; process a transaction based on the at least one condition; and in response to processing the transaction, transfer the particular ticket NFT to the user account.

Clause 4. The system of clause 3 or any other clause, wherein the at least one computing device is configured to process the transaction by transferring a particular amount to a user account associated with the particular asset NFT.

Clause 5. The system of clause 4 or any other clause, wherein the particular amount comprises an amount of cryptocurrency and the user account comprises a cryptographic wallet.

Clause 6. The system of clause 3 or any other clause, wherein the at least one condition is a cost percentage owed to an owner of the particular asset in order to transfer the particular ticket NFT.

Clause 7. The system of clause 3 or any other clause, wherein the particular asset comprises a smart contract and the smart contract comprises the at least one condition.

Clause 8. A method, comprising: receiving, via one of one or more computing devices, a plurality of assets associated with a physical entity; creating, via one of the one or more computing devices, a plurality of asset non-fungible tokens (NFTs) individually associated with a respective one of the plurality of assets; generating, via one of the one or more computing devices, a plurality of tickets; creating, via one of the one or more computing devices, a plurality of ticket NFTs individually associated with a respective asset of the plurality of assets and based on the respective asset, wherein the plurality of ticket NFTs are for a particular event at the physical entity; and determining, via one of the one or more computing devices, to grant access to a particular asset at the physical entity during the particular event based on analyzing a particular ticket NFT of the plurality of ticket NFTs that is associated with the particular asset.

Clause 9. The method of clause 8 or any other clause, wherein creating the plurality of ticket NFTs comprises minting unique tokens individual corresponding to the plurality of ticket NFTs.

Clause 10. The method of clause 8 or any other clause, wherein creating the plurality of ticket NFTs further comprises receiving, via one of the one or more computing devices, a data representing at least one set of parameters for generating individually ones of the plurality of ticket NFTs associated with a respective one of the plurality of asset NFTs.

Clause 11. The method of clause 10 or any other clause, further comprising generating, via one of the one or more computing devices, the individually ones of the plurality of ticket NFTs by applying a respective one of the at least one set of parameters to an associated one of the plurality of asset NFTs.

Clause 12. The method of clause 10 or any other clause, wherein receiving the plurality of assets associated with the physical entity comprises receiving a list of seat locations in a stadium.

Clause 13. The method of clause 8 or any other clause, further comprising storing, via one of the one or more computing devices, the particular ticket NFT in a multi-signature digital wallet.

Clause 14. The method of clause 8 or any other clause, further comprising rendering, via one of the one or more computing devices, mapping of the physical entity comprising at least one status indicator associated with a subset of the plurality of ticket NFTs.

Clause 15. A system, comprising: a data store; and at least one computing device in communication with the data store, wherein the at least one computing device is configured to: receive a plurality of assets associated with a physical entity; generate a plurality of asset non-fungible tokens (NFTs) individually associated with a respective one of the plurality of assets; generate a plurality of ticket NFTs individually associated with a respective asset of the plurality of assets and based on the respective asset, wherein the plurality of ticket NFTs are for a particular event at the physical entity; and grant access to a particular asset at the physical entity during the particular event based on analyzing a particular ticket NFT of the plurality of ticket NFTs that is associated with the particular asset.

Clause 16. The system of clause 15 or any other clause, wherein the at least one computing device is further configured to: receive a request to transfer the particular ticket NFT to a particular user account; and record a transfer of the particular ticket NFT to the particular user account in a distributed ledger.

Clause 17. The system of clause 16 or any other clause, wherein the distributed ledger comprises a block chain.

Clause 18. The system of clause 16 or any other clause, wherein transferring the particular ticket NFT via the distributed ledger comprises obtaining authorization from a particular asset NFT of the plurality of asset NFTs associated with the particular asset.

Clause 19. The system of clause 18 or any other clause, wherein the authorization is obtained via a cryptographic token corresponding to the particular asset NFT.

Clause 20. The system of clause 15 or any other clause, wherein the physical entity comprises at least one of: a stadium, a cinema, or a theater, and the plurality of assets comprise a plurality of seats in the physical entity.

While various aspects have been described in the context of a preferred embodiment, additional aspects, features, and methodologies of the claimed innovations will be readily discernible from the description herein, by those of ordinary skill in the art. Many embodiments and adaptations of the disclosure and claimed innovations, as well as many variations, modifications, and equivalent arrangements and methodologies, will be apparent from or reasonably suggested by the disclosure and the foregoing description thereof, without departing from the substance or scope of the claims. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed innovations. In addition, some steps may be carried out simultaneously, contemporaneously, or in synchronization with other steps.

The embodiments were chosen and described in order to explain the principles of the claimed innovations and their practical application so as to enable others skilled in the art to utilize the innovations and various embodiments and with various modifications as are suited to the particular use contemplated. Alternative embodiments will become apparent to those skilled in the art to which the claimed innovations pertain without departing from their spirit and scope. Accordingly, the scope of the claimed innovations is defined by the appended claims rather than the foregoing description and the exemplary embodiments described therein.

What is claimed is:

1. A system, comprising:
a data store; and
at least one computing device in communication with the data store, wherein the at least one computing device is configured to:
receive a plurality of assets associated with a physical entity;
create a plurality of asset non-fungible tokens (NFTs) individually associated with a respective one of the plurality of assets;
create a plurality of ticket NFTs individually associated with a respective asset of the plurality of assets and based on a respective asset NFT of the plurality of asset NFTs associated with the respective asset, wherein the plurality of ticket NFTs are for a particular event at the physical entity; and
determine whether to grant access to a particular asset at the physical entity during the particular event based on analyzing a particular ticket NFT of the plurality of ticket NFTs that is associated with the particular asset.

2. The system of claim 1, wherein the at least one computing device is configured to:
receive a request to initiate a transfer of the particular ticket NFT to a user account, wherein a particular asset NFT of the plurality of asset NFTs associated with the particular asset;
determine that the particular asset NFT is associated with the particular ticket NFT based on the particular ticket NFT;
determine at least one condition associated with the particular asset NFT;
determine whether the at least one condition is satisfied; and
in response to the at least one condition being satisfied, transfer the particular ticket NFT to the user account.

3. The system of claim 1, wherein the at least one computing device is configured to:
receive a request to initiate a transfer of the particular ticket NFT to a user account, wherein a particular asset NFT of the plurality of asset NFTs associated with the particular asset;
determine that the particular asset NFT is associated with the particular ticket NFT based on the particular ticket NFT;
determine at least one condition associated with the particular asset NFT;
process a transaction based on the at least one condition; and
in response to processing the transaction, transfer the particular ticket NFT to the user account.

4. The system of claim 3, wherein the at least one computing device is configured to process the transaction by transferring a particular amount to a user account associated with the particular asset NFT.

5. The system of claim 4, wherein the particular amount comprises an amount of cryptocurrency and the user account comprises a cryptographic wallet.

6. The system of claim 3, wherein the at least one condition is a cost percentage owed to an owner of the particular asset in order to transfer the particular ticket NFT.

7. The system of claim 3, wherein the particular asset comprises a smart contract and the smart contract comprises the at least one condition.

8. A method, comprising:
receiving, via one of one or more computing devices, a plurality of assets associated with a physical entity;
creating, via one of the one or more computing devices, a plurality of asset non-fungible tokens (NFTs) individually associated with a respective one of the plurality of assets;
generating, via one of the one or more computing devices, a plurality of tickets;
creating, via one of the one or more computing devices, a plurality of ticket NFTs individually associated with a respective asset of the plurality of assets and based on the respective asset, wherein the plurality of ticket NFTs are for a particular event at the physical entity; and
determining, via one of the one or more computing devices, to grant access to a particular asset at the physical entity during the particular event based on analyzing a particular ticket NFT of the plurality of ticket NFTs that is associated with the particular asset.

9. The method of claim 8, wherein creating the plurality of ticket NFTs comprises minting unique tokens individual corresponding to the plurality of ticket NFTs.

10. The method of claim 8, wherein creating the plurality of ticket NFTs further comprises receiving, via one of the one or more computing devices, a data representing at least one set of parameters for generating individually ones of the plurality of ticket NFTs associated with a respective one of the plurality of asset NFTs.

11. The method of claim 10, further comprising generating, via one of the one or more computing devices, the individually ones of the plurality of ticket NFTs by applying a respective one of the at least one set of parameters to an associated one of the plurality of asset NFTs.

12. The method of claim 10, wherein receiving the plurality of assets associated with the physical entity comprises receiving a list of seat locations in a stadium.

13. The method of claim 8, further comprising storing, via one of the one or more computing devices, the particular ticket NFT in a multi-signature digital wallet.

14. The method of claim 8, further comprising rendering, via one of the one or more computing devices, mapping of the physical entity comprising at least one status indicator associated with a subset of the plurality of ticket NFTs.

15. A system, comprising:
a data store; and
at least one computing device in communication with the data store, wherein the at least one computing device is configured to:
receive a plurality of assets associated with a physical entity;
generate a plurality of asset non-fungible tokens (NFTs) individually associated with a respective one of the plurality of assets;
generate a plurality of ticket NFTs individually associated with a respective asset of the plurality of assets and based on the respective asset, wherein the plurality of ticket NFTs are for a particular event at the physical entity; and
grant access to a particular asset at the physical entity during the particular event based on analyzing a particular ticket NFT of the plurality of ticket NFTs that is associated with the particular asset.

16. The system of claim 15, wherein the at least one computing device is further configured to:
receive a request to transfer the particular ticket NFT to a particular user account; and
record a transfer of the particular ticket NFT to the particular user account in a distributed ledger.

17. The system of claim 16, wherein the distributed ledger comprises a block chain.

18. The system of claim 16, wherein transferring the particular ticket NFT via the distributed ledger comprises obtaining authorization from a particular asset NFT of the plurality of asset NFTs associated with the particular asset.

19. The system of claim 18, wherein the authorization is obtained via a cryptographic token corresponding to the particular asset NFT.

20. The system of claim 15, wherein the physical entity comprises at least one of: a stadium, a cinema, or a theater, and the plurality of assets comprise a plurality of seats in the physical entity.
